(19) United States
(12) Patent Application Publication
(10) Pub. No.: US 2016/0123228 A1
(43) Pub. Date: May 5, 2016

(54) AIR INTAKE SLEEVE FOR AN AIRCRAFT TURBOPROP ENGINE

(71) Applicant: SNECMA, Paris (FR)

(72) Inventors: Alexandre Gerard Francois Couilleaux, Morsang Sur Orge (FR); Romain Jean Claude Ferrier, Brunoy (FR); Nicolas Joseph Sirvin, Brunoy (FR)

(21) Appl. No.: 14/924,437

(22) Filed: Oct. 27, 2015

(30) Foreign Application Priority Data
Oct. 29, 2014 (FR) 1460369

(51) Int. Cl. F02C 7/055; B64D 13/06; F04D 29/32; F02C 9/18; F01D 9/06

(52) U.S. Cl. CPC F02C 7/055; F02C 9/18; F01D 9/06; F04D 29/321; B64D 13/06; F05D 2220/36; F05D 2260/20; F05D 2260/606

(57) ABSTRACT

Air intake sleeve (32) for an aircraft turboprop engine, comprising an air bleed duct (54) that is oriented substantially along a first axis (A) and a duct (56) for supplying air to a compressor, which duct is oriented substantially along a second axis (B), at a distance from the first axis and substantially in parallel with the first axis, said air bleed duct and said supply duct being interconnected by an intermediate duct (60) having a general S shape, when viewed from the side, characterised in that said intermediate duct comprises, on at least one of the walls thereof, means for sucking air into the flow path of the intermediate duct, said suction means (64, 66) being positioned and/or designed to suck a boundary layer of said flow path.

### TECHNICAL FIELD

The present invention relates to an air intake sleeve for an aircraft turboprop engine.

### PRIOR ART

An air intake sleeve for an aircraft turboprop engine generally comprises an air bleed duct that is oriented substantially along a first axis and at least one duct for supplying air to a compressor, which duct is oriented substantially along a second axis, at a distance from the first axis and substantially in parallel with the first axis, in particular to leave space for a power transmission gear box, which draws its power from a turbine in order to provide it to a propeller of the turboprop engine. The bleed duct receives the air that is fed to the supply duct in order to provide a bleed-air flow to the engine of the turboprop engine. This sleeve may further comprise a particle-discharge duct, which extends substantially along the first axis and makes it possible to discharge foreign bodies so that they do not enter the engine of the turboprop engine.

The air intake sleeve comprises an intermediate duct that has a relatively complex shape and forms a connecting part between the bleed duct and the supply duct, said discharge duct extending substantially in the extension of the bleed duct.

When viewed from the side, the intermediate duct has a general S shape of which the upstream and lower end is connected to the bleed duct and of which the downstream and upper end is connected to the supply duct. The supply duct is positioned above the discharge duct and the intermediate duct forms a “rising” part for connecting the bleed duct to the supply duct. There are other types of air intake, each of these air intakes comprising a connecting part forming a diversion of the air flow.

The air intake sleeve has the function of supplying the engine with air in the most homogenous manner possible. However, the complex shape of the above-mentioned sleeve generates distortions in the air flow supplying the engine, and this has a negative impact on the surge margin of the compressor of the engine. This distortion is essentially due to the shedding of air owing to the significant diversion of the air flow in the above-mentioned connecting part. In a particular case, the cross section of the air flow in the sleeve changes from upstream to downstream, starting from a substantially elliptical cross section towards a C-shaped cross section of which the opening is oriented upwards, and then there is separation from the particle-discharge duct. The C-shaped cross section changes such that the ends facing this cross section merge to form an annular cross section, that is to say in an O-shape. The presence of turbulence has been noted in the ends of the C-shaped cross section, which causes two zones of low total pressure at the outlet of the sleeve.

The present invention proposes a simple, effective and economical solution to this problem.

### SUMMARY OF THE INVENTION

The invention proposes an air intake sleeve for an aircraft turboprop engine, comprising an air bleed duct that is oriented substantially along a first axis and a duct for supplying air to a compressor, which duct is oriented substantially along a second axis, at a distance from the first axis and substantially in parallel with the first axis, said bleed duct and said supply duct being interconnected by an intermediate duct having a general S shape, when viewed from the side, said intermediate duct comprising, on at least one of the walls thereof, means for sucking air from the flow path of the intermediate duct, said suction means being positioned and/or designed to suck a boundary layer of said flow path, characterised in that said suction means are designed to produce the suction in a shedding zone of the boundary layer and in that said means are designed to be connected to an air conditioning circuit of a cabin of the aircraft.

Sucking in the air makes it possible to limit air shedding in the suction zone and thus to limit the risk of the above-mentioned distortion occurring. Moreover, the bled air may be used effectively and may for example be injected into an air conditioning circuit of a cabin of the aircraft equipped with the turboprop engine.

The sleeve according to the invention may comprise one or more of the following features, taken in isolation or in combination with one another:
said intermediate duct comprises an upstream portion that is connected to said bleed duct and a downstream portion that is connected to said supply duct, said upstream and downstream portions having cross-sectional widths L1 and L2 respectively, with L2 being greater than L1,
said suction means are positioned on an air-flow-diverting wall of said intermediate duct,
said diverting wall has a tangent that is inclined relative to said first and second axes,
said suction means are positioned on said upstream or downstream portion,
the sleeve comprises an air-discharge duct that is oriented substantially along said first axis, said supply duct being positioned above said discharge duct, and said suction means being positioned on an upper wall of said intermediate duct,
said suction means comprise a plurality of air-passage openings that open into said flow path,
said openings open onto an concave curved inner surface that defines said flow path,
said openings are formed by a grating or are formed directly in at least one wall that defines said flow path,
said openings open, on the side opposite said flow path, into a cavity in an air manifold,
the air manifold comprises an air outlet that is designed to be connected to said air conditioning circuit of the cabin of the aircraft, and
said shedding zone is positioned in a region or a wall of the sleeve which has a convex shape.

The present invention also relates to an aircraft turboprop engine, characterised in that it comprises a sleeve as described above.

### DESCRIPTION OF THE FIGURES

The invention will be better understood and other details, features and advantages of the invention will emerge from reading the following description, given by way of non-limiting example and with reference to the accompanying drawings, in which:

FIG. 1 is a highly schematic view of an aircraft turboprop engine,

FIG. 2 is a schematic view of the air intake sleeve of the turboprop engine in FIG. 1,

FIGS. 3a to 3e are schematic cross sections along lines IIIa-IIIa, IIIb-IIIb, IIIc-IIIc, IIId-IIId and IIIe-IIIe, respectively, through the air intake sleeve in FIG. 2,

FIGS. 4 and 5 are highly schematic plan views of an air intake sleeve, according to two variants of the invention,

FIG. 6a is a schematic side view of an air intake sleeve according to the invention,

FIG. 6b is a schematic cross section along line VIb-VIb in FIG. 6a, and

FIGS. 7 and 8 are highly schematic views of a turboprop engine equipped with an air intake sleeve, according to two variants of the invention.

### DETAILED DESCRIPTION

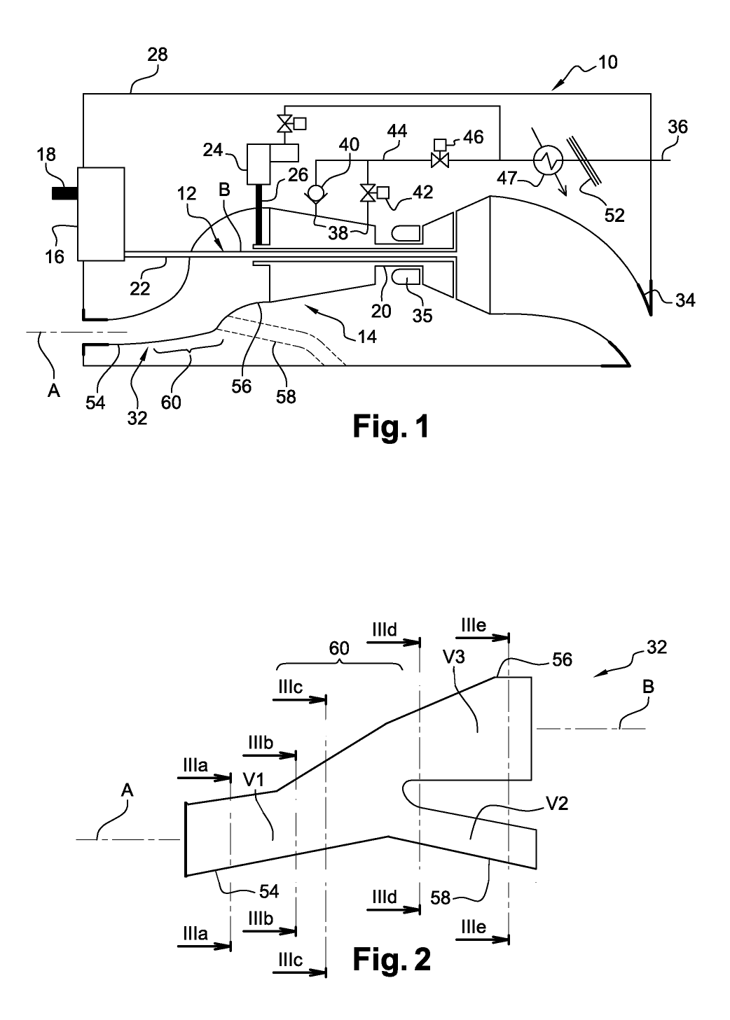

Reference is first made to FIG. 1, which shows a turboprop engine 10, according to the prior art, for an aircraft.

The turboprop engine 10 is of the twin-spool type and comprises a low-pressure spool 12 and a high-pressure spool 14, the low-pressure spool 12 driving a propeller by means of a gear box 16 or a reduction gear box, commonly referred to as a propeller gear box (PGB). Only the shaft 18 of the propeller is shown in FIG. 1.

In this case, the low-pressure spool 12 comprises only a turbine rotor connected by a shaft to the gear box 16. The high-pressure spool 14 comprises a compressor rotor connected by a shaft to a turbine rotor. The shaft of the high-pressure spool 14, referred to as the HP shaft 20, is tubular and passes coaxially through the shaft of the low-pressure spool 12, referred to as the LP shaft 22 or power shaft. At one end, the LP shaft 22 comprises a pinion (not shown) that is coupled to the shaft 18 of the propeller by means of a series of pinions of the gear box 16.

The turboprop engine 10 comprises an accessory gear box 24 (AGB) which is coupled to the high-pressure spool of the turbine engine 14, and in particular to the HP shaft, by means of a radial shaft 26. The accessory gear box 24 is mounted in the nacelle 28 of the turboprop engine 10, which is shown schematically by a rectangle.

The turboprop engine 10 further comprises an air intake sleeve 32 for supplying the engine with air, and a gas exhaust nozzle 34 for the combustion gases. The turboprop engine 10 further comprises a combustion chamber 35, between the HP compressor and the HP turbine.

The turboprop engine 10 is further equipped with means for bleeding air from an air conditioning circuit 36 of a cabin of the aircraft, said means conventionally comprising air-bleed means in the compressor of the turboprop engine 10. The compressor of the turboprop engine 10 is equipped with two ports 38 or a mouth for bleeding compressed air, each of these ports 38 being connected by a valve 40, 42 to an air-bleed pipe 44 of the circuit 36.

The first port 38 or upstream port (relative to the flow direction of the gases in the engine) makes it possible to bleed the air at an intermediate pressure. The valve 40 that is connected to this pipe 44 is of the non-return flap type.

The second port 38 or downstream port makes it possible to bleed the air at high pressure. The valve 42 that is connected to this pipe 44 is open when the pressure of the air bled by the valve 40 is not sufficient, the air bled by the valve 42 being prevented from being re-injected upstream by the non-return function of the flap of the valve 40.

The pipe 44 is equipped with a valve 46 which regulates the bleed pressure of the circuit 36, and with a heat exchanger 47 of the pre-cooler type, which is intended to reduce the temperature of the air before it is introduced into the circuit 36. The pipe 44 passes through a fire-protection partition 52 before being connected to the circuit 36.

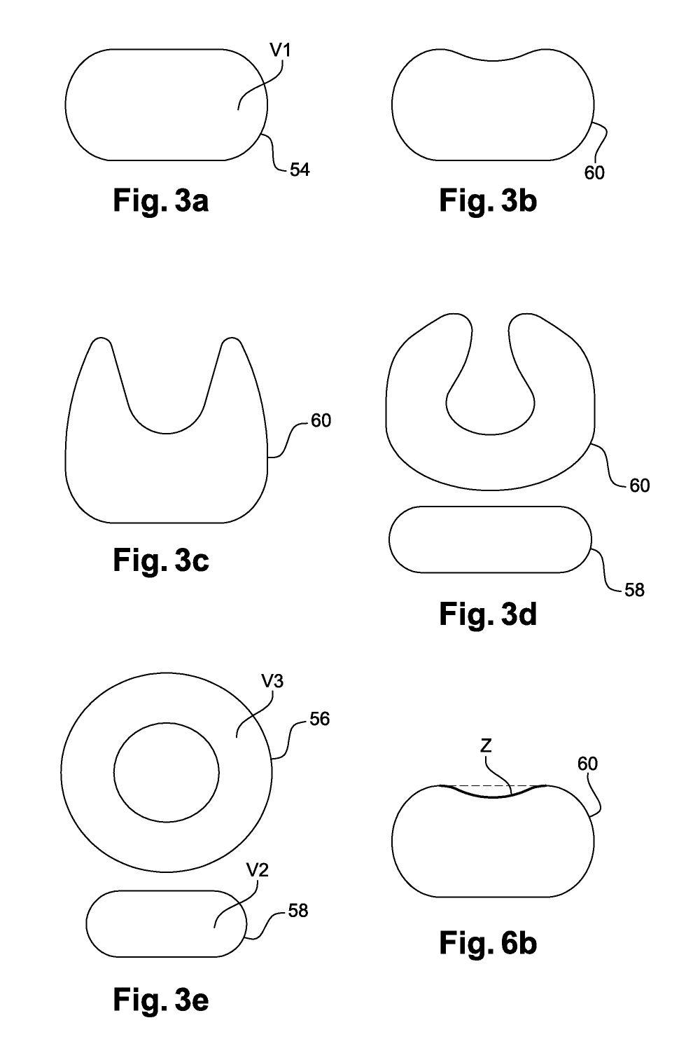

The present invention relates to the air intake sleeve 32 of a turboprop engine, which can be seen more clearly in FIGS. 2 and 3a to 3e.

The air intake sleeve 32 comprises an upstream or air bleed duct 54 that is oriented substantially along a first axis A and at least one first downstream duct or duct 56 for supplying air to the compressor, this duct 56 being oriented substantially along a second axis B, at a distance from the axis A and substantially in parallel with the axis A. In the example shown, the sleeve 32 comprises a second downstream duct or particle-discharge duct 58 which extends substantially along the axis A. This duct 58 is shown by dashed lines in FIG. 1.

The ducts 54 and 56 are interconnected by an intermediate duct 60 that has a relatively complex shape. When viewed from the side in FIG. 2, the intermediate duct 60 has a general S shape of which the upstream and lower end is connected to the duct 54 and of which the downstream and upper end is connected to the duct 56. It is a downstream and lower end of the intermediate duct that is connected to the duct 58.

The supply duct 56 is offset from the discharge duct 58 in order to leave space for a power transmission gear box, which draws its power from the turbine in order to provide it to the propeller of the turboprop engine. The intermediate duct 60 forms a part, in this case a “rising” part, for connecting the bleed duct 54 to the supply duct 56. FIGS. 3a to 3e show the change in the cross section of the air flow in the sleeve. FIG. 3a shows the cross section, which is elliptical in this case, of the duct 54 which defines a flow path V1. FIG. 3e shows the cross sections of the ducts 56, 58, the duct 56 having an annular cross section and defining a flow path V3 and the duct 58 having an elliptical cross section and defining a flow path V2. FIGS. 3b to 3d show the change in the cross section of the intermediate duct 60. In FIGS. 3c and 3d, the intermediate duct 60 is in a C-shape, the opening of which is oriented upwards. The cross section of the duct 60 changes from upstream to downstream such that the free ends thereof merge gradually until they form the annular cross section in FIG. 3e.

It is thus understood that the flow path V1 is intended to divide in the intermediate duct 60 into a flow path V2 in the discharge duct 58 and into a flow path V3 in the supply duct 56, the flow path V3 being the only annular flow path, as can be seen in FIG. 3e.

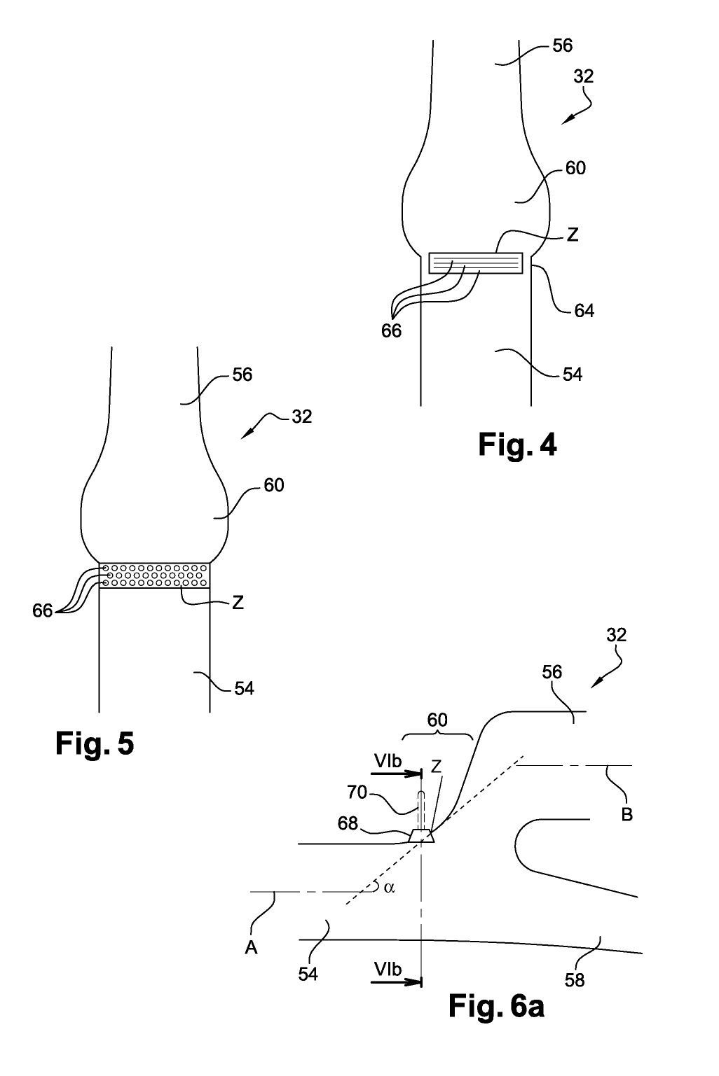

The sleeve 32 has the function of supplying the engine with air in the most homogenous manner possible. However, the complex shape of the sleeve 32 generates distortions in the air flow supplying the engine, and this has a negative impact on the surge margin of the compressor of the engine. This distortion is essentially due to the shedding present in the above-mentioned connecting part (having the most significant diversion of the air flow), in the zone Z shown in FIGS. 4, 5 and 6a. This distortion generates turbulence in the sleeve 32, which causes zones of low total pressure at the outlet of the sleeve 32. The connecting part having the most significant diversion of the air flow can be better seen in FIG. 6a, which shows that the tangent of the wall of the intermediate duct 60, on which the zone Z is located, is inclined at an angle α relative to the axes A, B, which in this case are substantially parallel. The greater the angle α of this tangent, the more the air flow is diverted into the sleeve, in order to pass from the flow path V1 of the upstream duct 54 into the flow path V3 of the downstream duct 56.

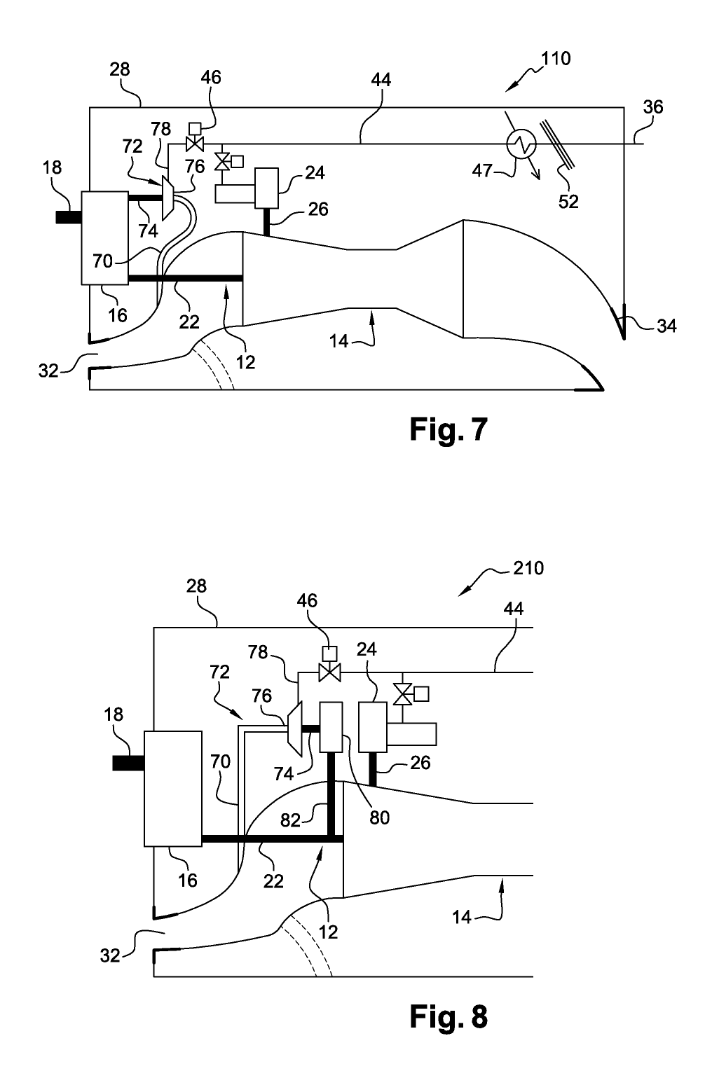

In order to reduce the influence of this shedding zone Z, the invention proposes producing suction of the boundary layer in this zone. This suction may be produced by the air bleeding that is required for supplying a load compressor for supplying air to an air conditioning circuit of a cabin of an aircraft, as will be described in greater detail in the following with reference to FIGS. 7 and 8.

The air bleeding in the sleeve 32 may be carried out in different ways, the common point preferably being distributing the suction over substantially the entire extension of the upper surface of the sleeve 32 in the shedding zone Z, which is the source of the distortion.

According to a first embodiment shown highly schematically in FIG. 4, the suction takes place by means of a grating 64, which defines a plurality of air-passage openings 66. The openings 66 may be in any shape, for example an elongate shape, and thus may be likened to slots.

The grating 64 is positioned in the shedding zone Z. This grating 64 is placed over the upper part of the sleeve and may have various shapes and meshes (grid, honeycomb, etc.), of which the aim is to minimise the head loss over the bleeding.

As can be seen in FIGS. 4 and 5, the intermediate duct 60 of the sleeve 32 comprises a part in the region of the arms that has a width L2 that is greater than the width L1 of the ducts 54, 56. In this case, the grating 64 is positioned just upstream of the arms 62, at the connection between the duct 54 and the intermediate duct 60.

The aim of this is to provide the most homogeneous suction possible over the surface in question, using a system that is relatively simple to implement.

In the variant in FIG. 5, the suction takes place by means of a plurality of openings 66 that are formed directly in the wall of the sleeve 32, which is located in the zone Z.

The benefit of this variant is that the suction can be adjusted locally on the basis of two criteria: the density of the openings 66 in the zone Z and the diameter thereof.

In the variants in FIGS. 4 and 5, the openings 66 open at a (lower) end into the flow path of the intermediate duct 60 and at the opposite (upper) end thereof into a collector cavity of a manifold 68, which is mounted on the sleeve 32 to cover the zone Z comprising the openings 66 (cf. FIG. 6a). In the particular case shown in FIG. 6b, the above-mentioned zone Z is located in a recess in the cross section.

The manifold 68 may have an elongate shape so as to extend along the entire width L1 of the sleeve 32. It comprises an air outlet that is connected to an end of a conduit 70, of which the opposite end may be connected to the air intake of a load compressor.

FIGS. 7 and 8 show two embodiments of a turboprop engine according to the invention, in which the elements that have already been described above are denoted by the same reference signs.

The turboprop engine 110 in FIG. 2 differs from that in FIG. 1 essentially on account of the air-bleed means of the circuit 36.

In this case, these bleed means comprise a dedicated compressor 72 of which the rotor 74 is coupled by the gear box 16 to the low-pressure spool 12 and in particular to the LP shaft 22.

The compressor 72 comprises an air intake 76 and an air outlet 78. In the example shown, the air intake 76 is connected by a conduit 70 to the air intake sleeve 32 of the turboprop engine 110, in the above-mentioned zone Z. Relatively cool air is thus bled by the conduit 70 in order to supply the compressor 72.

The air outlet 78 of the compressor 72 is connected to the air-bleed pipe 44 of the circuit 36. As described above, this pipe 44 comprises a valve 46 which regulates the bleed pressure of the circuit 36, and a heat exchanger 47 of the pre-cooler type, which is intended to reduce the temperature of the air before it is introduced into the circuit 36.

The turboprop engine 210 in FIG. 7 differs from that in FIG. 2 essentially in that the rotor 61 of the compressor 72 is coupled to the LP shaft 22 not by the gear box 16, but by another gear box 80, which may be intended for ensuring this function of coupling the LP shaft to the rotor of the compressor 72. The gear box 80 may be coupled to the LP shaft 22 by means of a radial shaft 82. The air intake 62 of the compressor 72 is connected by a conduit 70 to the air intake sleeve 32 of the turboprop engine 110, in the above-mentioned zone Z.

1. Air intake sleeve for an aircraft turboprop engine, comprising an air bleed duct that is oriented substantially along a first axis and a duct for supplying air to a compressor, which duct is oriented substantially along a second axis, at a distance from the first axis and substantially in parallel with the first axis, said air bleed duct and said supply duct being interconnected by an intermediate duct having a general S shape, when viewed from the side, said intermediate duct comprising, on at least one of the walls thereof, means for sucking air from the flow path of the intermediate duct, said suction means being positioned and/or designed to suck a boundary layer of said flow path, characterised in that said suction means are designed to produce the suction in a shedding zone of the boundary layer and in that said means are designed to be connected to an air conditioning circuit of a cabin of the aircraft.

2. Sleeve according to claim 1, wherein said suction means are positioned on an air-flow-diverting wall of said intermediate duct.

3. Sleeve according to claim 2, wherein said diverting wall has a tangent that is inclined relative to said first and second axes.

4. Sleeve according to claim 1, wherein it comprises an air-discharge duct that is oriented substantially along said first axis, said supply duct being positioned above said discharge duct, and said suction means being positioned on an upper wall of said intermediate duct.

5. Sleeve according to claim 1, wherein said suction means comprise a plurality of air-passage openings that open into said flow path.

6. Sleeve according to claim 5, wherein said openings open onto a convex curved inner surface that defines said flow path.

7. Sleeve according to claim 5, wherein said openings are formed by a grating or are formed directly in at least one wall that defines said flow path.

8. Sleeve according to claim 5, wherein said openings open, on the side opposite said flow path, into a cavity in an air manifold.

9. Sleeve according to claim 8, wherein the air manifold comprises an air outlet that is designed to be connected to said air conditioning circuit of the cabin of the aircraft.

10. Sleeve according to claim 1, wherein said shedding zone is positioned in a region or a wall of the sleeve which has a convex shape.

11. Turboprop engine for an aircraft, characterised in that it comprises a sleeve according to claim 1.
